(19) United States
(12) Patent Application Publication
(10) Pub. No.: US 2008/0183762 A1
(43) Pub. Date: Jul. 31, 2008

(54) DOCUMENT MANAGEMENT APPARATUS AND DOCUMENT MANAGEMENT METHOD

(75) Inventor: Noriyuki Komamura, Shizuoka-ken (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/668,176

(22) Filed: Jan. 29, 2007

(51) Int. Cl. G06F 17/30; G06F 9/46

(52) U.S. Cl. 707/200; 719/318

(57) ABSTRACT

A document management apparatus of the invention has an object to automatically extract, in a case where information of an electronic document having a printing history in the past is changed, difference information at any time and to manage, display and print it according to needs of a user, and includes a document management unit to manage electronic documents created based on electronic data, an operation event detection unit to monitor and detect operation events related to the electronic documents, a printing history determination unit to determine, based on a detected operation event, the presence or absence of a printing history of an electronic document having a specified relation to an electronic document related to the operation event among the managed electronic documents, and an operation event notification control unit to notify, with respect to the electronic document determined to have the printing history, content of the operation event to a user who has performed printing of the electronic document.

### BACKGROUND OF THE INVENTION

1. Field of the Related Art The present invention relates to a document management apparatus for managing an electronic document having a printing history in the past, and a document management method.

2. Description of the Related Art

In general, a paper document is separated from an electronic document of a print original at the time point when it is once printed. Thus, in the case where a correction, such as editing or deletion, is added to the electronic document of the print original, when its operator is the person himself or herself who owns the paper document, he or she can recognize that a difference occurs between the printed paper document and the present corrected electronic document. However, in the case where the correction operation is performed by a person other than the person himself or herself, the owner of the paper document does not know that the correction has been added to the electronic document, and manages the old paper document and advances the business, while not noticing that the owned paper document has already become old information.

With respect to the problem as stated above, there is known document 1 (JP-A-11-249777) relating to a document management system in which an operation history relating to an electronic document in a system is positively used for management of a document outside the system, such as a paper document outputted from the system, so that the convenience is remarkably improved.

Further, there is known document 2 (JP-A-2000-194518) relating to a print processing apparatus, a print processing system, a print processing method and a recording medium in which print data including plural pages is received, the received print data is made to correspond to specified identification information and is stored in a storage unit, and the print data is print-processed, and particularly to a document management system in which in a case where a part of the print data is changed, only a changed page is efficiently printed, the use of wasteful print sheets is reduced, and resource saving can be realized.

However, in the technique of the document 1, since the user having outputted the paper document is notified that the electronic document is updated, the user can recognize the fact, however, the user can not recognize information as to “which portion of the document is corrected in what manner”. Thus, in the case where there are many corrected portions, or in the case where a correction liable to be overlooked at first glance has been made, it is conceivable that the user cannot recognize the accurate corrected place and corrected content.

The technique of the document 2 is effective in that “difference printing” is performed by the function of the printing apparatus so that the user himself or herself can recognize that the managed paper document has been corrected in what manner. However, until the user carries out the “difference printing”, there is no means for knowing the information relating to the corrected place or corrected content.

### SUMMARY OF THE INVENTION

The invention has been made in view of the foregoing problem, and it is an object to provide a technique in which in a case where information of an electronic document as the original of a paper document currently owned by the user is corrected, that can be easily known.

In order to solve the problem, a document management apparatus of the invention includes a document management unit configured to manage electronic documents created based on electronic data, an operation event detection unit configured to monitor and detect operation events related to the electronic documents, a printing history determination unit configured to determine, based on an operation event detected by the operation event detection unit, the presence or absence of a printing history of an electronic document having a specified relation to an electronic document related to the operation event among the electronic documents managed by the document management unit, and an operation event notification control unit configured to notify, with respect to the electronic document determined to have the printing history by the print history determination unit, content of the operation event to a user who has performed printing of the electronic document.

Besides, there are included document management means for managing electronic documents created based on electronic data, operation event detection means for monitoring and detecting operation events related to the electronic documents, printing history determination means for determining, based on an operation event detected by the operation event detection means, the presence or absence of a printing history of an electronic document having a specified relation to an electronic document related to the operation event among the electronic documents managed by the document management means, and operation event notification control means for notifying, with respect to the electronic document determined to have the printing history by the print history determination means, content of the operation event to a user who has performed printing of the electronic document.

Besides, a document management method of the invention includes managing electronic documents created based on electronic data, monitoring and detecting operation events related to the electronic documents, determining, based on a detected operation event, the presence or absence of a printing history of an electronic document having a specified relation to an electronic document related to the operation event among the managed electronic documents, notifying, with respect to the electronic document determined to have the printing history, content of the operation event to a user who has performed printing of the electronic document.

### DESCRIPTION OF THE DRAWINGS

FIG. 1 is a block diagram showing a structure of a document management system of the invention.

FIG. 2 is a block diagram showing a structure of a document management apparatus of the invention.

FIG. 3 is a flowchart showing a processing operation of the document management apparatus of the invention.

FIG. 4 shows an example of data registered in a history information management unit.

FIG. 5 shows an example of a setting screen of a printing history retrieval object document.

FIG. 6 shows an example of a display method setting screen of difference information.

FIG. 7 shows an example of a notification screen of an operation event to a relevant document.

FIG. 8 shows an example of a print method setting screen of difference information.

FIG. 9 is a view for explaining a file creation method at the time when documents before change and after change are arranged side by side and are printed.

FIG. 10 shows an example of a notification screen at the time when a document is deleted.

### DESCRIPTION OF THE EMBODIMENT

Hereinafter, embodiments of the invention will be described with reference to the drawings.

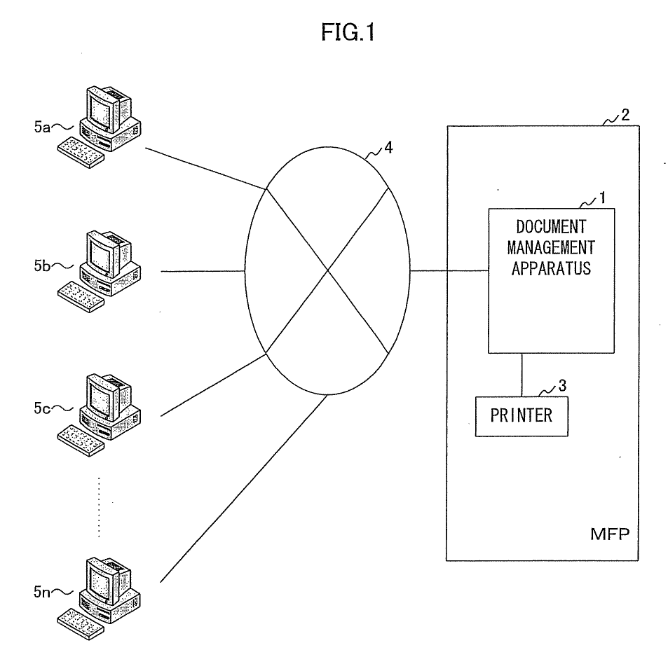

FIG. 1 is a block diagram showing a structure of a document management system of the invention. Incidentally, an MFP includes a printer 3.

A document management apparatus 1 is one of components in the MFP (Multi Function Peripheral) 2 and is connected to clients 5a, 5b, 5c . . . 5n through a network 4.

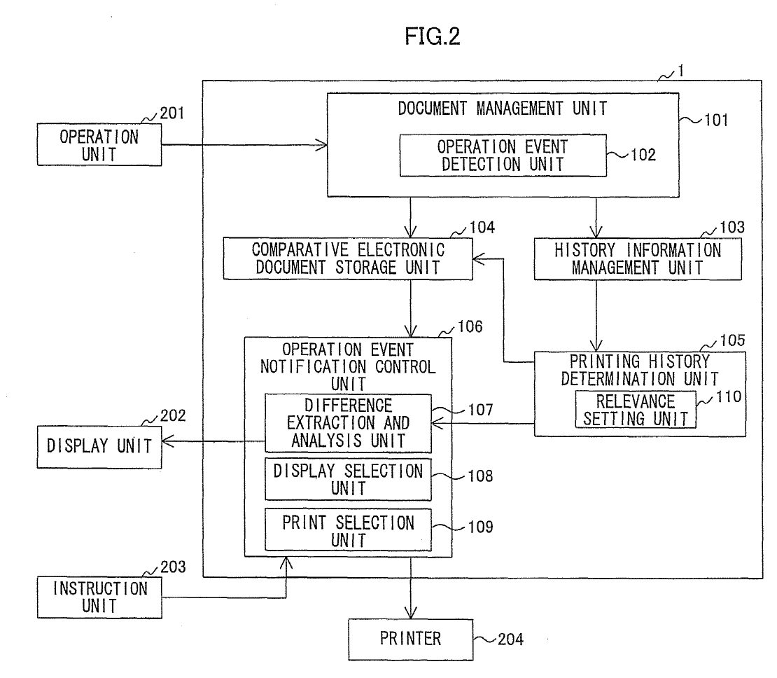

FIG. 2 is a block diagram showing a structure of the document management apparatus 1. The document management apparatus 1 includes a document management unit (document management means) 101, a history information management unit 103, a comparative electronic document storage unit 104, a printing history determination unit (printing history determination means) 105, and an operation event notification control unit (operation event notification control means) 106.

The document management unit 101 includes an operation event detection unit (operation event detection means) 102. The operation event notification control unit 106 includes a difference extraction and analysis unit 107, a display selection unit (display selection means) 108 and a print selection unit (print selection means) 109. Further, the printing history determination unit 105 includes a relevance setting unit 110.

Incidentally, the document management apparatus 1 can communicate with an operation unit 201, a display unit 202, an instruction unit 203 and a printer 204 provided at the client 5a to 5n side.

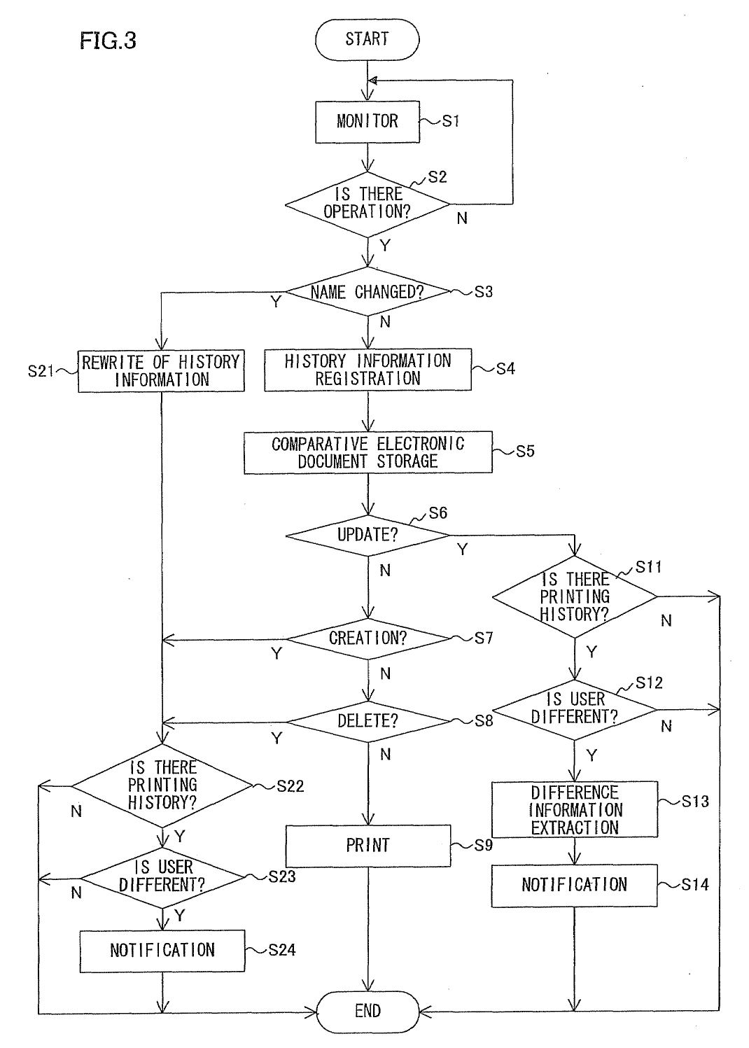

A processing operation in the document management apparatus 1 having the structure as stated above will be described by use of a flowchart of FIG. 3.

When the processing is started, the operation event detection unit 102 starts to monitor whether or not there is an access or an operation event from the operation unit 201 to an electronic document managed by the document management unit 101 (step S1).

When the operation event detection unit 102 detects that some operation event has occurred (step S2, Y), in the case where the operation event is not a change of a file name of a document (step S3, N), the operation information is registered in the history information management unit 103 (step S4).

The content registered in the history information management unit 103 includes an operation date, the content of the operation event (creation, update, storage, deletion, printing, etc.), an operator (user name, account, machine name, etc.), determination information (file name, full path, etc.) of an operated document, and attribute information (category, genre, all aspects of metadata defined in the file).

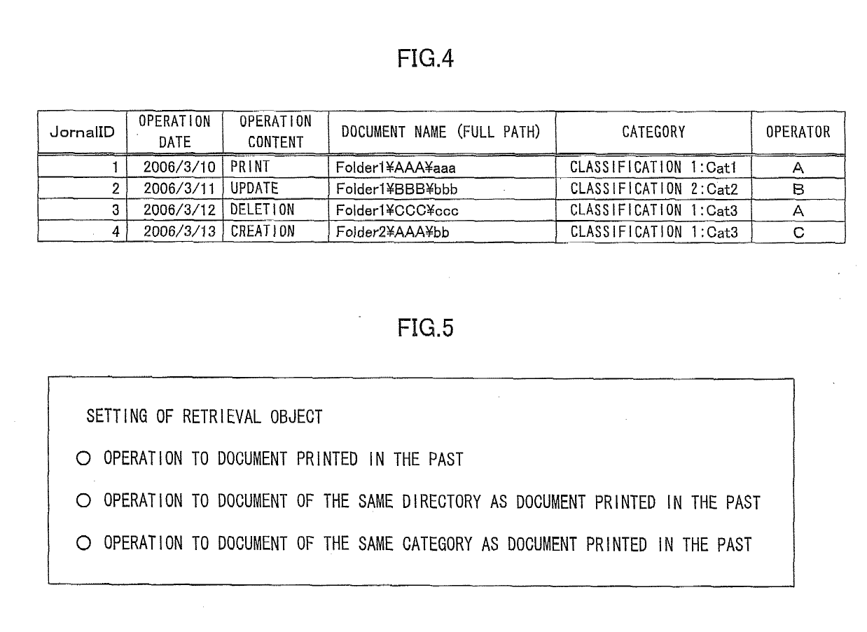

Incidentally, FIG. 4 shows an example of data registered in the history information management unit 103.

In the “category” information registered in the history information management unit 103, there is a case where the attribute information (metadata) related to the document includes information to classify the document, and in that case, the classification information is also acquired and is registered in the history information management unit 103. When the electronic document is data of a file DB, the registered “classification”, “genre” and the like are registered.

Further, after registering the operation information in the history information management unit 103, the operation event detection unit 102 transmits the electronic document after the operation to the comparative electronic document storage unit 104 for copying (step S5).

Incidentally, since the file of the electronic document copied in the comparative electronic document storage unit 104 is used in the after-mentioned difference extraction and analysis unit 107 at the time of a difference extraction processing, copying (registration) is performed in the comparative electronic document storage unit 104 in a data form (format) which can be used in the difference extraction and analysis unit 107. In the case where the electronic document is in such a data form that a processing (comparison) can not be performed in the difference extraction and analysis unit 107, format conversion is performed, and the registration into the comparative electronic document storage unit 104 is performed.

Next, in the case where the content of the operation information newly registered in the history information management unit 103 is “update” (step S6, Y), the printing history determination unit 105 determines whether or not the electronic document and an electronic document having a specified relation thereto were printed in the past (step S11).

Here, the reason why the object range of the printing history retrieval (range of the determination object of the presence or absence of the printing history) is not limited to the operated electronic document but is extended to the electronic document having the specified relation thereto is as follows.

For example, in a folder in which the specifications of a certain project are managed, the user having printed the specifications document in the folder is often concerned with the project. In such a case, there is a high possibility that the other electronic documents in the same folder are the documents relating to the business (project), and it is preferable that the user grasps the content of those electronic documents irrespective of the presence or absence of the printing by the user. From the above, in the case where another user performs an operation, such as a change, on an electronic document in the same directory or category as a document printed by a user, it is conceivable that it is advantageous for the user who has performed the printing that the operation is also placed in a state where the user can know it.

The relevance setting unit 110 provided in the printing history determination unit 105 presents a screen (setting screen) as shown in FIG. 5 on the display unit 202 at the client side, and the object range of the printing history retrieval can be made to be set by the user.

Next, in the case where the document or a document included in the same directory or category as the document was printed in the past (step S11, Y), and the user having performed the printing is different from the user of the operation (step S12, Y), a difference information extraction processing is performed by the difference extraction and analysis unit 107 (step S13).

The difference information extraction processing at the step S13 is performed in such a way that the electronic document corresponding to the document file printed in the past and stored in the comparative electronic document storage unit 104 is compared with the updated new electronic document, and difference information is extracted.

The extracted information is displayed on the display unit 202 at the client side by the operation event notification control unit 106 and is notified to the user (step S14).

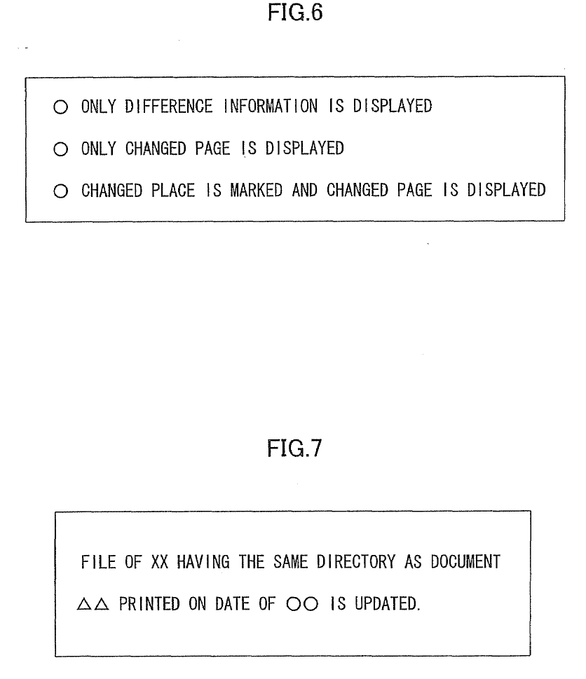

Incidentally, with respect to this notification method, in this embodiment, the user can select one of plural notification methods by the display selection unit 108 provided in the operation event notification control unit 106. For example, on the display unit 202 at the client side, a selection screen (corresponding to the instruction unit 203 shown in FIG. 1) as shown in FIG. 6 is presented, and the user is made to select a desired display method.

Besides, in the case where the “update” operation is performed on the document existing in the same directory or category as the document printed in the past, the user is notified by, for example, a screen as shown in FIG. 7.

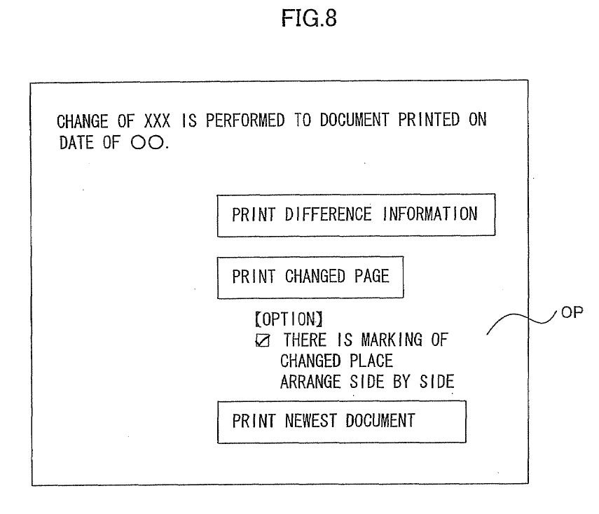

Further, the user can output the displayed difference information as a paper document as the need arises. At that time, the print selection unit (print selection means) 109 of the operation event notification control unit 106 presents a selection screen as shown in FIG. 8 on the display unit 202 at the client side, and the user is made to select a desired printing method (printing form).

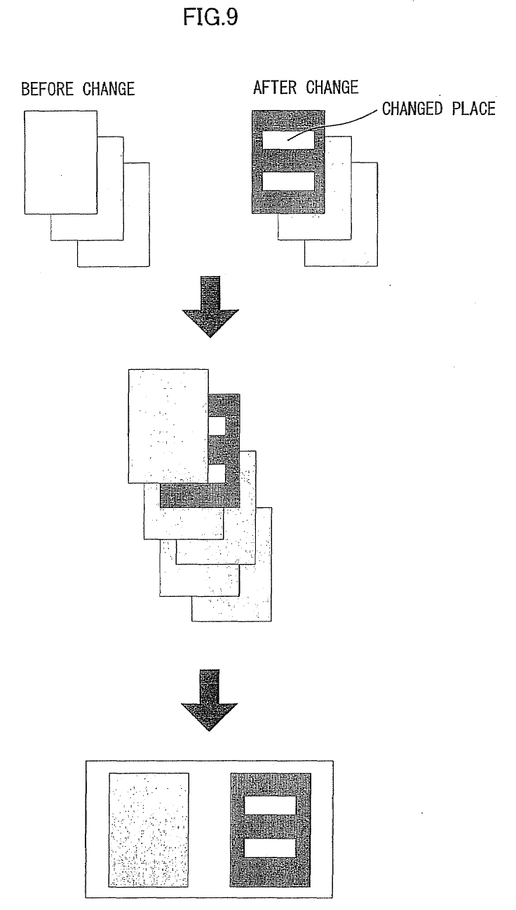

Besides, on the selection screen shown in FIG. 8, in the case where an option OP to arrange the document before the change and the document after the change side by side and to print them is selected, documents are previously created in which one before the change and one after the change are arranged every page in accordance with a rule as shown in FIG. 9, and they are outputted in 2in1 at the time of printing, so that the printing in which the documents are arranged side by side becomes possible. Incidentally, before this printing, the print screen (2in1 screen) is displayed on the display screen at the client side, and the user can be made to confirm.

Incidentally, at this time, head characters or images of the pages before the change and after the change are made coincident with each other. In the case where the addition to the page after the change is increased, and the page number becomes inconsistent with the page before the change, a measure is taken by inserting a blank page in the page before the change.

Next, in the case where the content of the operation information newly registered in the history information management unit 103 is not “update” (step S6, N) but “creation” (step S7, Y), the printing history determination unit 105 determines whether or not that the document or a document existing in the same directory or category as the document was printed in the past (step S22).

In this determination, when it is determined that printing was made (step S22, Y), and the user having performed the printing is another user different from the user of the operation (step S23, Y), the operation event notification control unit 106 displays on the display unit 202 at the client side that the electronic document is created, and notifies the user having printed the document (step S24).

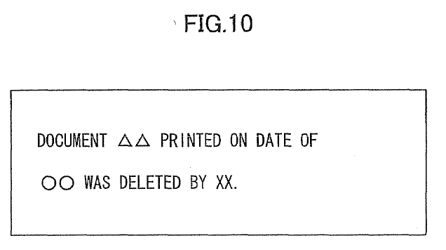

Also in the case where the content of the operation information is not “creation” (step S7, N) but “deletion (step S8, Y), this notification operation (step S22 to step S24) is similarly performed. Incidentally, in the case where the electronic document is deleted, a screen as shown in FIG. 10 is displayed on the display unit 202 of the client.

By the structure as stated above, irrespective of a paper document or an electronic document, when the document becomes unnecessary, the electronic document is deleted, and the user is triggered to discard the paper document. When the document is not required to be the electronic document, the necessity of the paper document is increased, and the improvement of a keeping method or a management place is triggered. Further, even in the case where the electronic document is erroneously deleted, when it is found that the printed paper document exists, a measure corresponding thereto can also be taken.

On the other hand, in the case where the content of the operation information newly registered in the history information management unit 103 is not “deletion” (step S8, N), it is determined that a printing operation is performed and the printing processing is performed (step S9), and the series of flow is ended.

Incidentally, in the case where the operation event on the electronic document detected at step S2 is the change of the file name (step S3, Y), in the history information management unit 103, as rewriting of the history information, the management place (full path) of the item of the document is rewritten (step S21). At this time, the copy transfer to the comparative electronic document storage unit 104 is not performed, and a shift is made directly to step S22 and the following steps.

As described above in detail, according to the embodiment of the invention, in the case where a change in an electronic document occurs, the place is automatically extracted at any time, and based on the information of the displayed place, the user is made to determine “whether printing is performed” when necessary, and in the case where the user desires printing, even in the printer normally used by the user and having no “difference printing” function, the difference information can be easily printed.

Incidentally, the document management means, the operation event detection means, the printing history determination means and the operation event notification control means described in the embodiment can be applied also to a program to cause a computer to execute the document management method described in the flowchart shown in the embodiment.

This program is recorded on a computer readable recording medium, is read by the computer, and has a function to cause the computer to execute the document management method of the invention.

With respect to the function as stated above, in the embodiment, although the description has been made on the case where the function to carry out the invention is previously recorded in the inside of the apparatus, no limitation is made to this, and a similar function may be downloaded from a network to the apparatus, or a similar function recorded on a recording medium may be installed in the apparatus. As the recording medium, any form may be adopted as long as the recording medium, such as a CD-ROM, can store the program and can be read by the apparatus. Besides, the function obtained by the previous installation or download may realize the function by cooperation with an OS (Operating System) of the inside of the apparatus.

What is claimed is:

1. A document management apparatus comprising:
a document management unit configured to manage electronic documents created based on electronic data;
an operation event detection unit configured to monitor and detect operation events related to the electronic documents;
a printing history determination unit configured to determine, based on an operation event detected by the operation event detection unit, the presence or absence of a printing history of an electronic document having a specified relation to an electronic document related to the operation event among the electronic documents managed by the document management unit; and
an operation event notification control unit configured to notify, with respect to the electronic document determined to have the printing history by the print history determination unit, content of the operation event to a user who has performed printing of the electronic document.

2. The document management apparatus according to claim 1, further comprising
a difference extraction unit capable of extracting a difference between two electronic documents, wherein
in a case where the operation event is an update event of an electronic document, the printing history determination unit determines the presence or absence of a printing history of, as the electronic document having the specified relation to the electronic document related to the update event, an electronic document before update of the electronic document related to the update event, and
the operation event notification control unit causes the difference extraction unit to extract a difference between the electronic document related to the update event and the electronic document before the update, and displays difference information based on the extraction result in the notification.

3. The document management apparatus according to claim 2, wherein the operation event notification control unit includes a display selection unit configured to cause a display mode of the difference information to be selected among plural modes.

4. The document management apparatus according to claim 2, wherein the operation event notification control unit causes the difference information, together with the notification, to be printed.

5. The document management apparatus according to claim 4, wherein the operation event notification control unit includes a print selection unit configured to cause a printing mode of the difference information to be selected among plural modes.

6. The document management apparatus according to claim 1, wherein the printing history determination unit includes a relevance setting unit that can set that an electronic document having, as the specified relation, what relation to the electronic document related to the operation event is made an object of determination of the presence or absence of the printing history.

7. The document management apparatus according to claim 1, wherein the electronic document having the specified relation to the electronic document related to the operation event is the electronic document whose directory is identical.

8. The document management apparatus according to claim 1, wherein the electronic document having the specified relation to the electronic document related to the operation event is the electronic document whose category is identical.

9. The document management apparatus according to claim 1, wherein the operation event includes a creation event to newly create an electronic document.

10. The document management apparatus according to claim 1, wherein the operation event includes a delete event to delete an electronic document.

11. The document management apparatus according to claim 1, wherein the document management unit manages an electronic document which has been printed.

12. The document management apparatus according to claim 1, wherein with respect to the electronic document determined to have the printing history by the printing history determination unit, the document management unit acquires a user name who has printed the electronic document and manages it.

13. A document management apparatus comprising:
document management means for managing electronic documents created based on electronic data;
operation event detection means for monitoring and detecting operation events related to the electronic documents;
printing history determination means for determining, based on an operation event detected by the operation event detection means, the presence or absence of a printing history of an electronic document having a specified relation to an electronic document related to the operation event among the electronic documents managed by the document management means; and
operation event notification control means for notifying, with respect to the electronic document determined to have the printing history by the print history determination means, content of the operation event to a user who has performed printing of the electronic document.

14. The document management apparatus according to claim 13, further comprising
difference extraction means for extracting a difference between two electronic documents, wherein
in a case where the operation event is an update event of an electronic document, the printing history determination means determines the presence or absence of a printing history of, as the electronic document having the specified relation to the electronic document related to the update event, an electronic document before update of the electronic document related to the update event, and
the operation event notification control means causes the difference extraction means to extract a difference between the electronic document related to the update event and the electronic document before the update, and displays difference information based on the extraction result in the notification.

15. The document management apparatus according to claim 14, wherein the operation event notification control means includes display selection means for causing a display mode of the difference information to be selected among plural modes.

16. The document management apparatus according to claim 14, wherein the operation event notification control means causes the difference information, together with the notification, to be printed.

17. The document management apparatus according to claim 16, wherein the operation event notification control means includes print selection means for causing a printing mode of the difference information to be selected among plural modes.

18. The document management apparatus according to claim 13, wherein the printing history determination means includes relevance setting means that can set that an electronic document having, as the specified relation, what relation to the electronic document related to the operation event is made an object of determination of the presence or absence of the printing history.

19. A document management method comprising:
managing electronic documents created based on electronic data;
monitoring and detecting operation events related to the electronic documents;
determining, based on a detected operation event, the presence or absence of a printing history of an electronic document having a specified relation to an electronic document related to the operation event among the managed electronic documents; and
notifying, with respect to the electronic document determined to have the printing history, content of the operation event to a user who has performed printing of the electronic document.

20. The document management method according to claim 19, further comprising
extracting a difference between two electronic documents, wherein
in a case where the operation event is an update event of an electronic document, the presence or absence of a printing history of, as the electronic document having the specified relation to the electronic document related to the update event, an electronic document before update of the electronic document related to the update event is determined, and
a difference between the electronic document related to the update event and the electronic document before the update is extracted, and difference information based on the extraction result is displayed in the notification.
